(19) United States
(12) Patent Application Publication
(10) Pub. No.: US 2019/0316787 A1
(43) Pub. Date: Oct. 17, 2019

(54) MINERAL FIBRE INSULATION

(71) Applicants: Knauf Insulation SPRL, Vise (BE); Knauf Insulation, Inc., Shelbyville, IN (US)

(72) Inventors: Roger JACKSON, St. Helens (GB); Tony AINDOW, St. Helens (GB); George BAYBUTT, St. Helens (GB)

(21) Appl. No.: 16/451,880

(22) Filed: Jun. 25, 2019

Related U.S. Application Data
(63) Continuation of application No. 15/690,538, filed on Aug. 30, 2017.
Application No. 15/690,538 is a continuation of application No. 14/041,713, filed on Sep. 30, 2013, now abandoned.
Application No. 14/041,713 is a division of application No. 12/524,502, filed on Nov. 12, 2009, now abandoned.

(51) Int. Cl. F24C 15/34; D04H 1/4209; C04B 26/20; C03C 13/06; C04B 14/42; D04H 1/587; D04H 1/4218; C03C 25/26; D04H 1/42; C04B 30/02; C04B 26/28

(52) U.S. Cl. CPC F24C 15/34; D04H 1/4209; C04B 26/20; C03C 13/06; C04B 14/42; C04B 2111/1006; D04H 1/4218; C03C 25/26; D04H 1/42; C04B 30/02; C04B 26/28; D04H 1/587

(57) ABSTRACT

A mineral wool insulating product having improved off gassing characteristics is particularly adapted for high temperature applications.

### CROSS-REFERENCE TO RELATED APPLICATIONS

This application is a continuation of U.S. patent application Ser. No. 14/041,713, filed Sep. 30, 2013, which is a divisional of U.S. patent application Ser. No. 12/524,502 (now abandoned), filed Nov. 12, 2009, which is a U.S. national counterpart application filed under 35 U.S.C. § 371(b) of International Application Serial No. PCT/EP2007/050747, filed Jan. 25, 2007, the disclosures of which are hereby incorporated herein by reference.

### FIELD OF THE INVENTION

This invention relates to a mineral fibre insulating product, particularly having a low formaldehyde or formaldehyde free binder.

### BACKGROUND

Industry standard binders used for fibre insulation, for example glass wool and rock wool insulation are based on phenol formaldehyde. Whilst such binders can provide suitable properties to the insulating products there has for some time been a desire to move away from the use of phenol formaldehyde, particularly due to environmental considerations.

Furthermore, where the mineral fibre insulation material is used in products that operate at high temperatures, for example, as insulation for ranges, ovens and storage heaters, phenol formaldehyde binders generally give off an acrid smell when the products are first heated to their operating temperatures and sometimes until all or a significant portion of the binder has decomposed. Such odours are not appreciated by the purchaser of, for example, a new domestic oven, and can be perceived as a fault in the product.

This problem has led to the use of mineral fibre insulation with acrylic binders with low levels (0.2-0.3% by weight) of dedusting oil or needled products which do not contain any binder. Such products are generally expensive and their handling characteristics can be less than ideal. Alternatively, inorganic binders can be used avoid the presence of compounds which decompose or gas off at such temperatures. However, such products have significant levels of dust which is inconvenient for handling and assembly. For example, for use in an oven, the mineral insulating products must be cut to size, have passageways cut away and be assembled generally under compression into the oven body. These operations would be simplified if the presence or generation of dust from the insulation could be reduced or avoided.

One aim of the invention is to provide an improved insulation product particularly for such applications.

### SUMMARY

According to one aspect, the present invention provides a mineral fibre insulating material as defined in claim 1. Other aspects are defined in other independent claims. Preferred and/or alternative features are defined in the dependent claims.

### BRIEF DESCRIPTION OF THE DRAWING

FIG. 1 shows the form and dimensions of samples used for testing parting strength.

### DETAILED DESCRIPTION

The compounds referred to in relation to off gassing are believed to create pleasant odours the first time the insulating material is heated to operating temperature. Preferably, the off gassing consists essentially of the compounds referred to. The off-gassing may be due to or essentially due to decomposition of the binder.

The off-gassing may be analysed by a tube furnace test and/or by gas chromatography.

The domination in the off gassing may be in terms of odour.

The ketone may comprise or consist essentially of 2-cyclopenten-1-one.

The furans may comprise or consist essentially of 2,5 dimethyl-furan and/or furan and/or 3-methyl-2,5-furandione.

The off gassing may comprise at least 50 mg, 100 mg, 500 mg or 1000 mg or ketones and/or furans per kilogram of binder.

The dust level is measured according to the Dust Level Assessment Procedure described below. The dust level is preferably less than 10 g/m³, more preferably less than 5 g/m³ and most preferably less than 1 g/m³.

The mineral fibre insulating product may have the characteristics defined when first heated to a temperature of 200° C., and preferably when first heated to a temperature of 250° C. or 300° C., that is to say when newly provided for use and heated to this temperature.

Physical characteristics that may be conferred by the binder on the mineral wool insulation product can be assessed by measuring Recovered Thickness and/or by measuring Ordinary Parting Strength and/or Weathered Parting Strength. The procedures for measuring these characteristics are set out below. The levels defined facilitate handling of the mineral insulation.

A binder content of at least 0.5%, preferably at least 1% or 1.5% by weight may provide good resilience and/or recovery and/or strength to the mineral insulation. A binder content of up to 8% by weight may provide good physical properties whilst avoiding excess quantities of binder and/or excessive off gassing when heated to high temperatures. The binder content may be determined by loss on ignition.

As used herein, the term formaldehyde free means that the composition is substantially free from formaldehyde, does not liberate substantial formaldehyde as a result of drying or curing and preferably comprises less than one part per million by weight of formaldehyde.

The binder may:
be based on a reducing sugar; and/or
be based on reductosis; and/or
be based on an aldehyde containing sugars/and/or
include at least one reaction product of a carbohydrate reactant and an amine reactant; and/or
include at least one reaction product of a reducing sugar and an amine reactant; and/or
include at least one reaction product of a carbohydrate reactant and a polycarboxylic acid ammonium salt reactant; and/or
include at least one reaction product from a Maillard reaction.

The binder may be based on a combination of a polycarboxylic acid, for example citric acid, a sugar, for example dextrose, and a source of ammonia, for example ammonia solution. It may be based on a combination of ammonium citrate and dextrose. Where the binder is based on sugars and/or citric acid and or comprises significant —OH groups, it is particularly surprising that such levels of Weathered Parting Strength can be achieved. It would have been thought that the —OH groups for example in the sugars and/or citric acid would be readily subject to hydrolysis and that the binder would consequently loose significant strength in humid and/or weathering conditions.

The binder may comprise a silicon containing compound, particularly a silane; this may be an amino-substituted compound; it may be a silyl ether; it may facilitate adherence of the binder to the mineral fibres.

The binder may comprise melanoidins; it may be a thermoset binder; it may be thermally curable.

The binder may be one of those disclosed in International patent application n° PCT/US2006/028929, the contents of which is hereby incorporated by reference. The insulating material may be provided as a package. The package may comprise one or more mineral wool insulating products arranged and/or bound together, for example to facilitate transport; it may comprise an enveloping film, for example of a plastics material. The package may consist of a roll of insulating material or an assembly of individual slabs of insulating material. The insulating material may be provided in a compressed state. The insulating material may have
a nominal thickness in the range 1.5 to 20 cm, or in the range 2 to 12 cm; and/or
a thermal resistance R of R≥to 3 m² K/W, preferably R≥to 4 m² K/W at a thickness or 200 mm; and/or
a thermal resistance R of R≥to 1.5 m² K/W, preferably R≥to 2 m² K/W at a thickness or 100 mm; and/or
a density in the range 5-40 kg/m³.

The mineral fibres may be glass wool or rock wool; the fibres may have an average diameter between 2 and 9 microns; they may have an average length between 8 and 80 mm.

The mineral fibre insulating material may be advantageously used in heating devices adapted to operate at temperatures greater than 100° C. or greater than 200° C.; it may be particularly adapted for use in heating devices adapted to operate at temperatures greater than 400° C. or greater than 500° C., for example, self cleaning ovens and/or precipitators.

### EXAMPLE

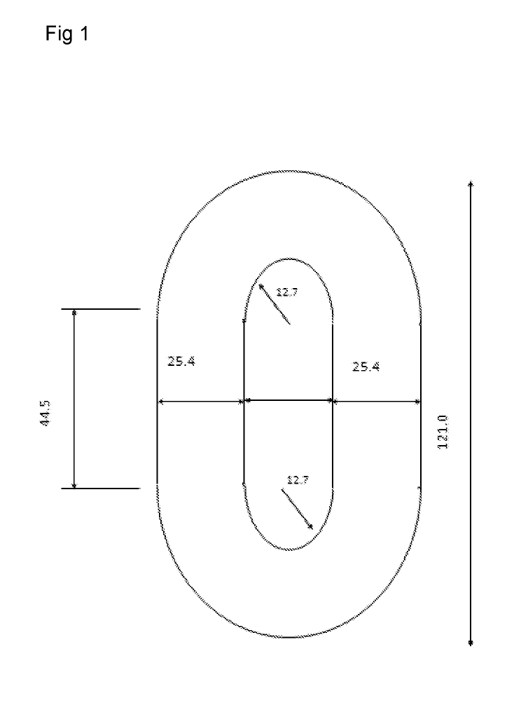

A non-limiting example of the invention is described below with reference to FIG. 1 which shows the form of samples used for testing parting strength.

An aqueous binder can be prepared by mixing together:

| | Approximate % by weight |
|---|---|
| Powdered dextrose monohydrate | 11% |
| Powdered anhydrous citric acid | 2% |
| Soft water | 84% |
| 19% aqueous ammonia | 3% |
| SILQUEST A-1101 silane | 0.05% |

This binder can be used in the manufacture of a fibre glass insulating product on a standard manufacturing line, the binder being sprayed onto glass fibres just after fiberising using internal spinners and the coated fibres being collected, assembled in to a mat and cured in the usual way.

The cured glass fibre insulating product can have:
a binder content of about 5% by weight as determined by loss on ignition
a thickness of about 100 mm
a density of about 12 kg/m3

Desired characteristics and results achieved are set out in Table 1:

TABLE 1

| | | Acceptance | | More | | Result |
|---|---|---|---|---|---|---|
| | Units | limit | Preferred | Preferred | Most preferred | achieved |
| Dust level | g/m³ | ≤20 | ≤10 | ≤5 | ≤1 | ≤1 |
| Recovered | % of | ≥95 | ≥100 | ≥110 | ≥120 | 103 |
| Thickness | nominal | | | | | |
| Ordinary | g/g | ≥95 | ≥100 | ≥150 | ≥200 | 122 |
| Parting | | | | | | |
| Strength | | | | | | |
| Weathered | g/g | ≥75 | ≥80 | ≥100 | ≥150 | 112 |
| Parting | | | | | | |
| strength | | | | | | |

When heated to about 200° C., the insulating material gave off a slight odour which was a pleasant baking smell.

Dust Level Assessment Procedure

Three specimens are cut from the test material using a 150 mm diameter cutter; the specimens should have clean edges and be free from dirt and foreign matter.

The first specimen is placed in the sieve of a Pascall Sieve Shaker; it should not be compressed by the lid but should fit snugly. If necessary, layers are built up to achieve this. The lid and receiver of the sieve are fitted and the complete unit is secured on to the Pascall Sieve Shaker and set to shake for 10 minutes.

When the shaker has stopped, the lid of the sieve is removed, the specimen is taken out and its weight recorded.

The procedure is repeated with the second and third specimens.

Once the three specimens have been shaken, the dust is collected from the receiver with the aid of a soft brush. The whole inner surface of the receiver should be gently brushed and the dust collected together prior to being transferred to a weighing dish and weighed to the nearest 0.0001g.

The dust level in g/m³ is calculated weight of dust collected from the three specimens and the total volume of the three specimens.

By way of precaution, all apparatus should be thoroughly clean and dry and free from grease before use. It may be washed in hot soapy water and dried completely before use.

Testing of Recovered Thickness:

Recovered Thickness is tested and measured in accordance with Annex A of British standard BS EN 823: 1995 (incorporated herein by reference) and expressed as a % of the nominal or announced thickness for the product measured.

Testing of Ordinary Parting Strength and Weathered Parting Strength:

Parting strength is a measure of the tensile strength of mineral fibre mats determined by placing an O shaped sample over cylindrical jaws, separating the jaws and measuring the load to break the fibres. Although it can be measured in Newtons per gram, the parting strength is expressed in grams/gram being the total breaking load of six test specimens divided by their total weight.

The test is carried out on mineral fibre mats as received for testing (Ordinary Parting Strength) and after an accelerated weathering test as explained below (Weathered Parting Strength).

A first set of six samples of the form and dimensions shown in FIG. 1 are cut from the mineral fibre mat to be tested; the long axis of the samples should be parallel to the conveyor direction and the samples should be taken across the full width of the mineral mat. A second set of six samples is then taken in the same way. The dimensions in FIG. 1 are in mm.

The total weight of the first group of six samples W1 in grams is recorded.

The total weight of the second group of six samples W2 in grams is recorded; these samples are then placed in a preheated autoclave and conditioned on a wire mesh shelf away from the bottom of the chamber under wet steam at 35 kN/m² for one hour. They are then removed, dried in an oven at 100° C. for five minutes and tested immediately for parting strength.

To test the parting strength, each sample is mounted in turn on the jaws of the tensile strength machine and the maximum breaking load in grams or Newtons is recorded. If the breaking load is measured in Newtons it is converted to grams by multiplying it by 101.9. Six results in grams are obtained for each set of samples: G1 G2 G3 G4 G5 and G6 for the first set of samples and G7 G8 G9 G10 G11 and G12 for the second set of samples.

The Ordinary Parting Strength is calculated from the first set of samples using the formula Ordinary Parting Strength=(G1+G2+G3+G4+G5+G6)/W1.

The Weathered Parting Strength is calculated from the second set of samples using the formula Weathered Parting Strength=(G7+G8+G9+G10+G11+G12)/W2.

1. A mineral fibre insulating material comprising at least 0.5% by weight of an organic binder and having an off-gassing dominated by ketones when first heated to a temperature of 200° C.

2. The mineral fibre insulating material in accordance with claim 1, in which the off gassing also comprises significant furans.

3. The mineral fibre insulating material in accordance with claim 1, in which the dust level is less than or equal to 20 g/m³.

4. A mineral fibre insulating material comprising at least 0.5% by weight of a binder, the material having a dust level of less than or equal to 20 g/m³ and off-gassing dominated by ketones when first heated to a temperature of 200° C.

5. The mineral fibre insulating material in accordance with claim 1, in which when first heated to a temperature of 200° C. off gassing of formaldehyde is less than 30 mg/kg.

6. The mineral fibre insulating material in accordance with claim 1 in which the off gassing gives predominantly baking odours.

7. The mineral fibre insulating material in accordance with claim 1 in which the Recovered Thickness is at least 100%.

8. The mineral fibre insulating material in accordance with claim 1 in which the Ordinary Parting Strength is at least 100 g/g.

9. The mineral fibre insulating material in accordance with claim 1, in which the Weathered Parting Strength is at least 80 g/g.

10. The mineral fibre insulating material in accordance with claim 1, in which the binder content is in the range 0.5 to 10% by weight.

11. The mineral fibre insulating material in accordance with claim 1, in which the binder is formaldehyde free.

12. The mineral fibre insulating material in accordance with claim 1, in which the binder is based on a reducing sugar.

13. The mineral fibre insulating material in accordance with claim 1, in which the binder comprises at least one Maillard reaction product.

14. The mineral fibre insulating material in accordance with claim 1, in which the binder is based on reaction products obtained by curing an aqueous solution comprising citric acid, ammonia and dextrose.

15. The mineral fibre insulating material in accordance with claim 1, in which the product has a density between 5 and 40 kg/m³.

16. A heating device adapted to operate at a temperature greater than 100 ° C. comprising a mineral fibre insulating material in accordance with claim 1.

17. An oven or range comprising a mineral fibre insulating material in accordance with claim 1.

18. A storage heater comprising a mineral fibre insulating material in accordance with claim 1.

19. A mineral fibre insulating material in accordance with claim 1 in a domestic oven, a self cleaning domestic oven, a range or a storage heater.
